(19) United States
(12) Patent Application Publication
(10) Pub. No.: US 2019/0015963 A1
(43) Pub. Date: Jan. 17, 2019

(54) POWER TOOL INCLUDING POWER TOOL BASE COUPLABLE WITH POWER TOOL IMPLEMENTS

(71) Applicant: TTI (MACAO COMMERCIAL OFFSHORE) LIMITED, Macau (MO)

(72) Inventors: Julia H. Moylan, Anderson, SC (US); Isiah D. Smith, Greenville, SC (US); Brent N. Gregorich, Easley, SC (US); Zachary Scott, Easley, SC (US); Brandon Causey, Greenville, SC (US)

(21) Appl. No.: 16/032,373

(22) Filed: Jul. 11, 2018

Related U.S. Application Data
(60) Provisional application No. 62/531,944, filed on Jul. 13, 2017.

(51) Int. Cl. B25F 5/02; B25F 3/00; B27C 9/02

(52) U.S. Cl. CPC B25F 5/021; B27C 9/02; B25F 3/00

(57) ABSTRACT

A power tool includes a power tool base having a base housing and a motor supported by the base housing. The power tool also includes a power tool implement selectively coupled to the power tool base. The power tool implement includes an implement housing and a working end coupled to the implement housing. One of the power tool base and the power tool implement includes a first interface portion having a protrusion. The other one of the power tool base and the power tool implement includes a second interface portion having an opening configured to receive the first interface portion. The power tool implement is coupled to the power tool base in response to axially moving the first interface portion into the second interface portion and rotating the implement housing relative to the base housing such that the protrusion of the first interface portion engages the second interface portion.

### CROSS-REFERENCE TO RELATED APPLICATIONS

This application claims priority to U.S. Provisional Patent Application No. 62/531,944 filed on Jul. 13, 2017, the content of which is incorporated herein by reference.

### BACKGROUND

The present invention relates to power tools and, more particularly to power tools including a power tool base couplable with a variety of power tool implements.

### SUMMARY

In one aspect, a power tool includes a power tool base having a base housing and a motor supported by the base housing. The power tool also includes a power tool implement selectively coupled to the power tool base. The power tool implement includes an implement housing and a working end coupled to the implement housing. One of the power tool base and the power tool implement includes a first interface portion having a protrusion. The other one of the power tool base and the power tool implement includes a second interface portion having an opening configured to receive the first interface portion. The power tool implement is coupled to the power tool base in response to axially moving the first interface portion into the second interface portion and rotating the implement housing relative to the base housing such that the protrusion of the first interface portion engages the second interface portion.

In another aspect, a power tool includes a power tool base having a base housing, a motor supported by the base housing, and a control processor coupled to the motor. The power tool also includes a power tool implement selectively coupled to the power tool base. The power tool implement includes an implement housing and a working end coupled to the implement housing. One of the power tool base and the power tool implement includes a first interface portion having a first electrical contact moveable relative to the one of the power tool base and the power tool implement in which the first interface portion is coupled to. The other one of the power tool base and the power tool implement includes a second interface portion having a second electrical contact fixed relative to the one of the power tool base and the power tool implement in which the second interface portion is coupled to. The control processor is electrically coupled to the power tool implement in response to the first electrical contact engaging the second electrical contact.

In yet another aspect, a power tool includes a power tool base configured to be selectively coupled to a power tool implement. The power tool base includes a housing having a front end, a motor supported by the housing, a control processor coupled to the motor, an output spindle driven by the motor about a rotational axis, and a mechanical interface portion coupled to the front end of the housing. The mechanical interface portion has a protrusion. The protrusion is configured to engage the power tool implement to mechanically couple the power tool base to the power tool implement. The power tool base also includes an electrical interface portion positioned adjacent the front end of the housing. The electrical interface portion movable relative to the mechanical interface portion. The electrical interface portion has a base electrical contact coupled to the control processor. The base electrical contact is configured to engage an implement electrical contact of the power tool implement to electrically couple the power tool implement to the power tool base.

In yet another aspect, a power tool includes a power tool implement configured to be selectively coupled to a power tool base. The power tool implement includes a housing having a cavity, a working end coupled to the housing, and a mechanical interface portion positioned within the cavity. The mechanical interface portion has a tab. The tab is configured to engage the power tool base to mechanically couple the power tool implement to the power tool base. The power tool implement also includes an electrical interface portion positioned within the cavity. The electrical interface portion has an implement electrical contact configured to engage a base electrical contact of the power tool base to electrically couple the power tool implement to the power tool base.

Other aspects of the invention will become apparent by consideration of the detailed description and accompanying drawings.

### BRIEF DESCRIPTION OF THE DRAWINGS

FIG. 1 is a perspective view of a power tool according to an embodiment of the invention including a power tool base and a power tool implement.

FIG. 2 is a perspective view of the power tool of FIG. 1 couplable to at least three power tool implements.

FIG. 3 is a perspective view of the power tool base of FIG. 1.

FIG. 4 is a partial perspective view of the power tool base of FIG. 3 with a portion of a housing of the power tool base removed.

FIG. 5 is a partial front view of the power tool base of FIG. 3.

FIG. 6 is a partial top view of the power tool base of FIG. 3.

FIG. 7 is a partial bottom view of the power tool base of FIG. 3.

FIG. 8 is a partial first perspective view of the power tool implement of FIG. 1.

FIG. 9 is a partial second perspective view of the power tool implement of FIG. 1.

FIG. 10 is rear view of the power tool implement of FIG. 8.

FIG. 11 is a cross sectional view taken along section line 11-11 of the power tool implement of FIG. 8.

FIG. 12 is a cross sectional view taken along section line 12-12 of the power tool implement of FIG. 8.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. Terms of degree, such as “substantially,” “about,” “approximately,” etc. are understood by those of ordinary skill to refer to reasonable ranges outside of the given value, for example, general tolerances associated with manufacturing, assembly, and use of the described embodiments.

### DETAILED DESCRIPTION

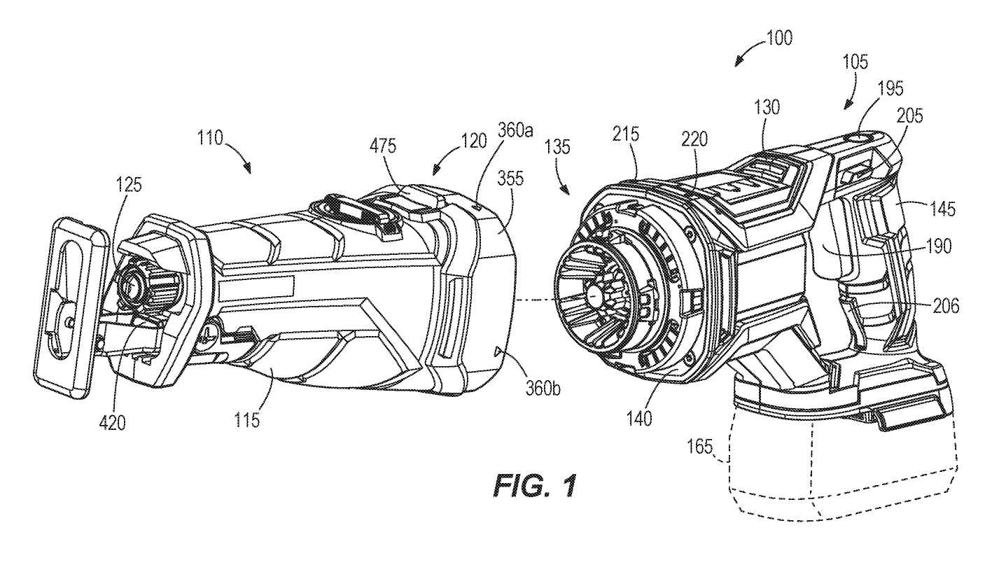

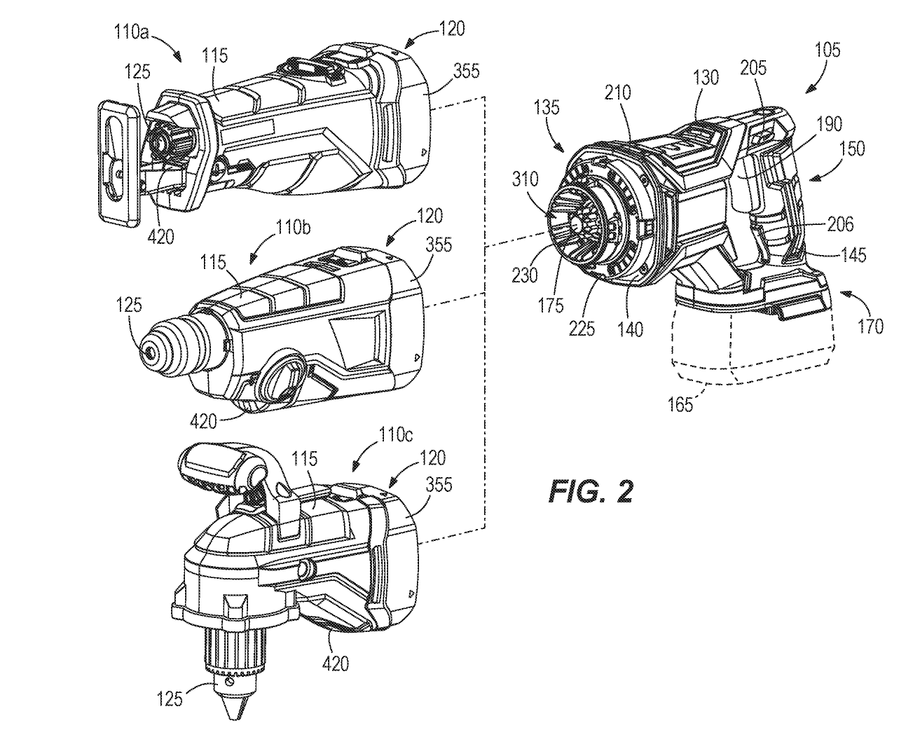

FIG. 1 illustrates a power tool 100 that includes a power tool base 105 and a power tool implement 110. In the illustrated embodiment, the power tool base 105 is selectively coupled to one of a plurality of power tool implements 110a, 110b, 110c (FIG. 2). For example, the illustrated first power tool implement 110a is a reciprocating saw implement, the illustrated second power tool implement 110b is a hammer drill implement, and the illustrated third power tool implement 110c is a 90-degree drill implement. In other embodiments, the power tool base 105 can be selectively coupled to more than three power tool implements 110. In further embodiments, the power tool implement 110 can be different types of power tool implements (e.g., rotary saw implement, shear implement, grinder implement, screwdriver implement, sander implement, magnetic levitation implement, jaw implement, etc.). Each power tool implement 110 includes a housing 115 having an attachment end 120 that interfaces with the power tool base 105 and a working end 125. In one embodiment, the working end 125 is a chuck that selectively secures a tool (e.g., a saw blade, a twist drill bit, a screwdriver tool bit, etc.) to the power tool implement 110.

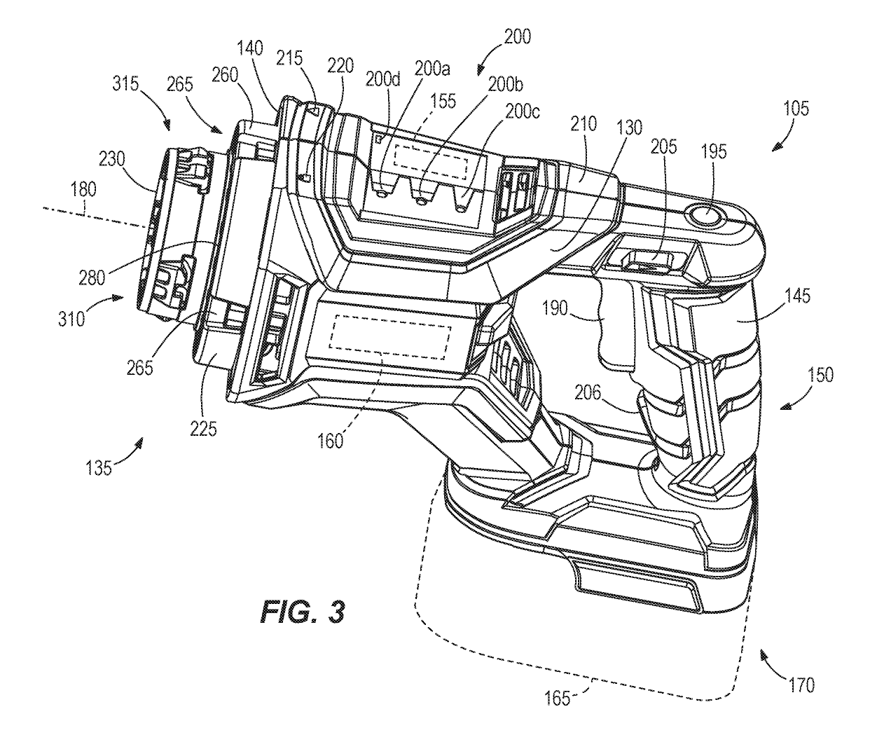

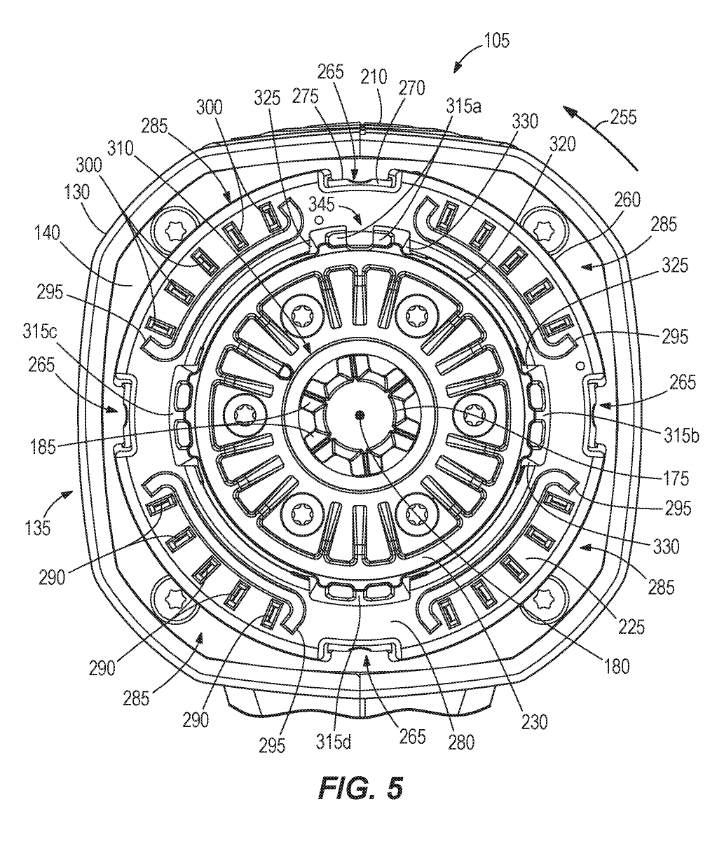

With reference to FIG. 3, the power tool base 105 includes a housing 130 with a power tool implement interface assembly 135 extending forwardly beyond a front plate or front end 140 of the housing 130 and a grip portion 145 located adjacent a rear end 150 of the housing 130. The housing 130 supports a controller 155 (e.g., electronic processor) and a drive unit 160 (e.g., a brushless electric motor) with the controller 155 electrically coupled to the drive unit 160. The drive unit 160 and the controller 155 are electrically coupled to a battery pack 165 (e.g., a lithium-ion battery pack, etc.), which is selectively coupled to a bottom side 170 of the housing 130. The drive unit 160 is also directly coupled (e.g., direct drive) to an output spindle 175 (FIG. 2) of the power tool implement interface assembly 135 to rotatably drive the output spindle 175 about a rotational axis 180. In other embodiments, the drive unit 160 can include a planetary transmission positioned between the output spindle 175 and the electric motor. The illustrated output spindle 175 includes teeth 185 that extend radially outward from the rotational axis 180 (FIG. 5).

With continued reference to FIG. 3, a power actuation trigger 190 is coupled to the grip portion 145 and is operable to provide electrical power from the battery pack 165 to the drive unit 160 to rotate the output spindle 175 about the rotational axis 180 once the power actuation trigger 190 is depressed into the grip portion 145. In one embodiment, in order to depress the power actuation trigger 190, a control button 195 is depressed (e.g., actuated) into the housing 130. Without depressing the control button 195, the power actuation trigger 190 cannot be depressed. As such, the control button 195 is a lock-out button to prevent inadvertent actuation of the power actuation trigger 190. In other embodiments, the control button 195 can be a lock-on button to maintain electrical power from the battery pack 165 to the drive unit 160 once the power actuation trigger 190 is released. In further embodiments, the control button 195 can be a lock-out button and a lock-on button.

The power tool base 105 also includes implement status indicators 200 (e.g., visual indicators and an audible indicator) that are coupled to a top surface 210 of the housing 130 (FIG. 3). In the illustrated embodiment, three light-emitting diodes 200a, 200b, 200c (e.g., LEDs) and a speaker 200d (e.g., a buzzer) are coupled to the controller 155 to visually and audibly indicate a status of the power tool implement 110 coupled to the power tool base 105. For example, the first LED 200a indicates when the power tool implement 110 is coupled to the power tool base 105, and the power tool implement 110 is ready to operate. The second LED 200b indicates whether the control button 195 has been or can be depressed to enable the lock-on function of the power actuation trigger 190. The third LED 200c indicates whether the control button 195 needs to be depressed to disable the lock-out function of the power actuation trigger 190. In other embodiments, the power tool base 105 can include more or less than three LEDs. The speaker 200d is operable to provide an audible alert in different sequences to indicate function availability of the power tool implement 110 (e.g., if the lock-on function can be enabled) and/or if an action is needed to operate the power tool implement 110 (e.g., disable the lock-off function). In further embodiments, the implement status indicators 200 can signal other statuses of the power tool implement 110 and the power tool base 105 (e.g., the power tool implement 110 is not properly coupled to the power tool base 105, the power tool implement 110 is overheating, the power actuation trigger 190 is actuated when the power tool implement 110 is not properly coupled to the power tool base 105, etc.).

The power tool base 105 further includes a directional actuation button 205 that is coupled to the housing 130 above the power actuation trigger 190. The directional actuation button 205 is operable to select a rotational direction of the output spindle 175. For example, when the directional actuation button 205 is in a first position, the output spindle 175 rotates in a first rotational direction and when the directional actuation button 205 is moved into a second position, the output spindle 175 rotates in an opposite second rotational direction. The directional actuation button 205 is also positionable in an intermediate position between the first and second positions so that the output spindle 175 is in a neutral (e.g., freely rotating) state. In some embodiments, the directional actuation button 205 is operational with some of the power tool implements 110 (e.g., the directional actuation button 205 is not operational with the reciprocating saw implement 110a, but the directional actuation button 205 is operational with the hammer drill implement 110b and the 90-degree drill implement 110c).

The housing 130 also supports a light actuation trigger 206 located on the grip portion 145 below the power actuation trigger 190 (FIG. 3). The light actuation trigger 206 selectively operates a light source that is coupled to the power tool implement 110, as described in more detail below.

With continued reference to FIG. 3, the housing 130 further includes a first alignment marking 215 and a lock alignment marking 220 located on the top side 210 of the housing 130 adjacent the power tool implement interface assembly 135. As described in more detail below, the first alignment marking 215 aids in alignment of the power tool base 105 with the power tool implement 110, and the lock alignment marking 220 represents when the power tool implement 110 is fully secured to the power tool base 105.

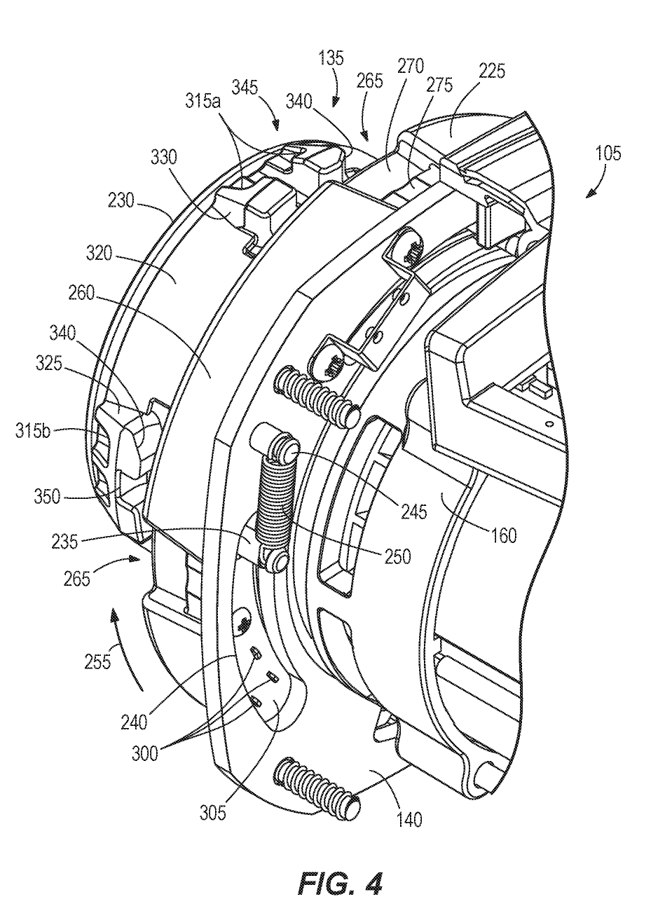

With reference to FIGS. 4-7, the illustrated tool implement interface assembly 135 includes an electrical interface portion or ring 225 and a mechanical interface portion or hub 230. The hub 230 is fixed relative to the housing 130, and the ring 225 is rotatably coupled to the housing 130 about the rotational axis 180. As shown in FIG. 4, the ring 225 is also biased about the rotational axis 180 relative to the hub 230. In particular, the ring 225 includes a ring pin 235 that extends through an arcuate opening 240 of the front plate 140 into the housing 130. Likewise, a plate pin 245 extends from the front plate 140 in the same direction as the ring pin 235. The ring pin 235 and the plate pin 245 are coupled together by a biasing member 250 (e.g., a coil spring), which is positioned within the housing 130. As such, the ring 225 is rotatably biased in a first direction 255 (e.g., counterclockwise direction as viewed in FIG. 5) relative to the hub 230. In other embodiments, the ring 225 can be rotatably biased in a clockwise direction relative to the hub 230 as viewed in FIG. 5. In further embodiments, more than one biasing member 250 can be coupled to the ring 225 and a portion of the housing 130 and/or the hub 230. In yet further embodiments, the ring 225 can be rotatably biased relative to the hub 230 by a different biasing member (e.g., a torsional spring).

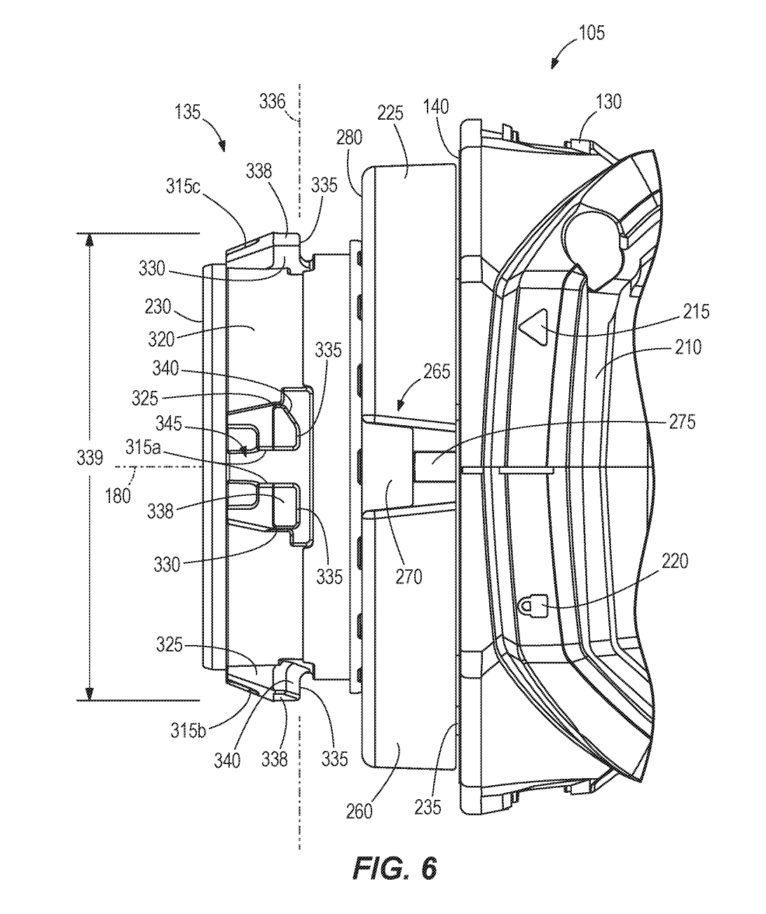

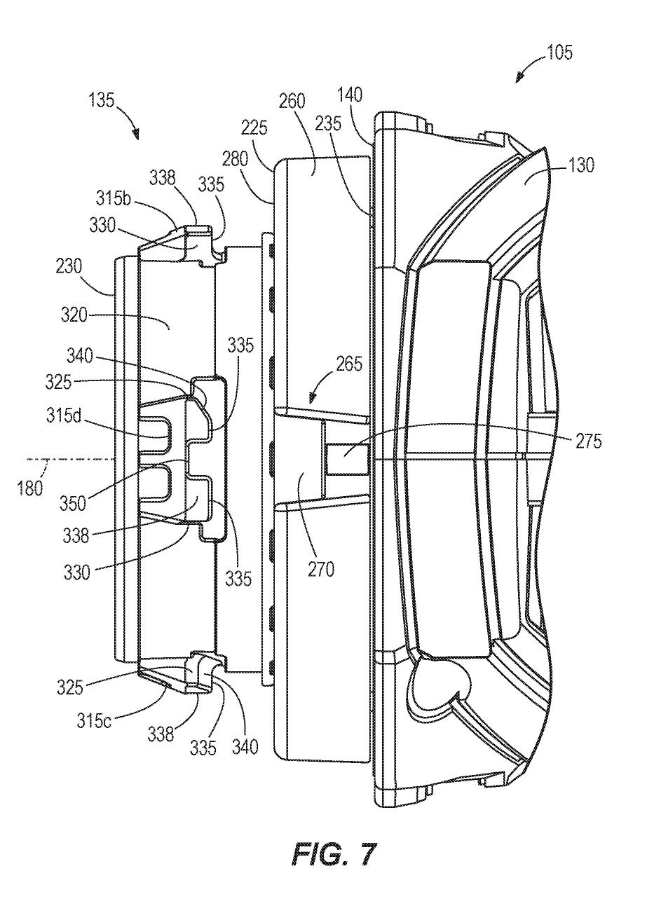

With continued reference to FIGS. 4-7, an outer circumference 260 of the ring 225 includes grooves 265. In the illustrated embodiment, the ring 225 includes four grooves 265 that are evenly spaced (e.g., spaced apart at 90 degree increments) around the outer circumference 260 of the ring 225. In other embodiments, the ring 225 may include more or less than four grooves 265. In further embodiments, the grooves 265 can be apertures formed within the ring 225 and/or grooves formed in an inner circumference of the ring 225. In the illustrated embodiment, each groove 265 defines a trapezoidal shaped groove that tapers in width in a direction toward the housing 130 (FIGS. 6 and 7). As best shown in FIGS. 4 and 5, each groove 265 also defines a first surface 270 positioned closer to the rotational axis 180 in a radial direction than a second surface 275 of each groove 265. The second surface 275 is also positioned between the first surface 270 and the front plate 140 in a direction along the rotational axis 180 (FIGS. 6 and 7).

The ring 225 also includes a front surface 280 that includes groups of interface members 285 (FIG. 5). In the illustrated embodiment, the groups of interface members 285 include four groups angularly spaced about the rotational axis 180. In other embodiments, the ring 225 can include more or less than four groups of interface members 285. Each illustrated group of interface members 285 includes electrical terminal apertures 290 (e.g., five electrical terminal apertures) and a guide aperture 295. In other embodiments, the groups of interface members 285 can include more or less than five electrical terminal apertures 290 and/or more than one guide aperture 295. Each illustrated electrical terminal aperture 290 provides access to one terminal connector 300 (e.g., a resilient terminal clip) with each terminal connector 300 coupled to a base printed circuit board 305 (e.g., PCB; FIG. 4). The base printed circuit board 305 is fixed to the ring 225 adjacent the front plate 140 (shown in FIG. 4) and is electrically coupled to the controller 155 so that the terminal connectors 300 are also electrically coupled to the controller 155.

With continued reference to FIG. 5, the hub 230 includes an inner cavity 310 in which the output spindle 175 is located. The hub 230 also includes protrusions 315 extending from an outer circumference 320 of the hub 230 (FIGS. 6 and 7). The protrusions 315 are positioned in front of the ring 225 in a direction along the rotational axis 180 (e.g., the ring 225 is positioned between the protrusions 315 and the housing 130 along the rotational axis 180). When the ring 225 is fully biased in the counterclockwise direction as shown in FIG. 5, each protrusion 315 aligns with a corresponding groove 265 in the radial direction. In the illustrated embodiment, the hub 230 includes four protrusions 315 evenly spaced (e.g., spaced at 90 degree increments) around the outer circumference 320 of the hub 230. In other embodiments, the protrusions 315 can include more or less than four protrusions. Each illustrated protrusion 315 includes a first side 325, a second side 330, and an abutment surface 335 extending between the first side 325 and the second side 330. The abutment surface 335 faces rearward toward the ring 225 and the housing 130 (FIGS. 6 and 7). As shown in FIG. 6, the abutment surfaces 335 of the four protrusions 315 collectively define a protrusion plane 336 that is perpendicular to the rotational axis 180. In addition, top surfaces 338 of the four protrusions 315 define an outer protrusion diameter 339 (FIG. 6). The first side 325 includes an edge 340 oriented at an oblique angle relative to the rotational axis 180 and the protrusion plane 336 (also shown in FIG. 6). In the illustrated embodiment, a top protrusion 315a includes a channel 345 extending through the abutment surface 335 in a direction along the rotational axis 180 (FIG. 6). In other words, the top protrusion 315a is separated into two discrete portions. However, the abutment surface 335 of two side protrusions 315b, 315c and a bottom protrusion 315d includes a notch 350 positioned between the first side 325 and the second side 330 (the notch 350 of the bottom protrusion 315d is shown in FIG. 7). In one embodiment, the channel 345 is operable to limit an orientation of the power tool implement 110 coupled to the power tool base 105. For example, the power tool implement 110 can interact with the channel 345 when the power tool implement 110 is coupled to the power tool base 105 so that the power tool implement 110 can only be coupled to the power tool base 105 in one orientation.

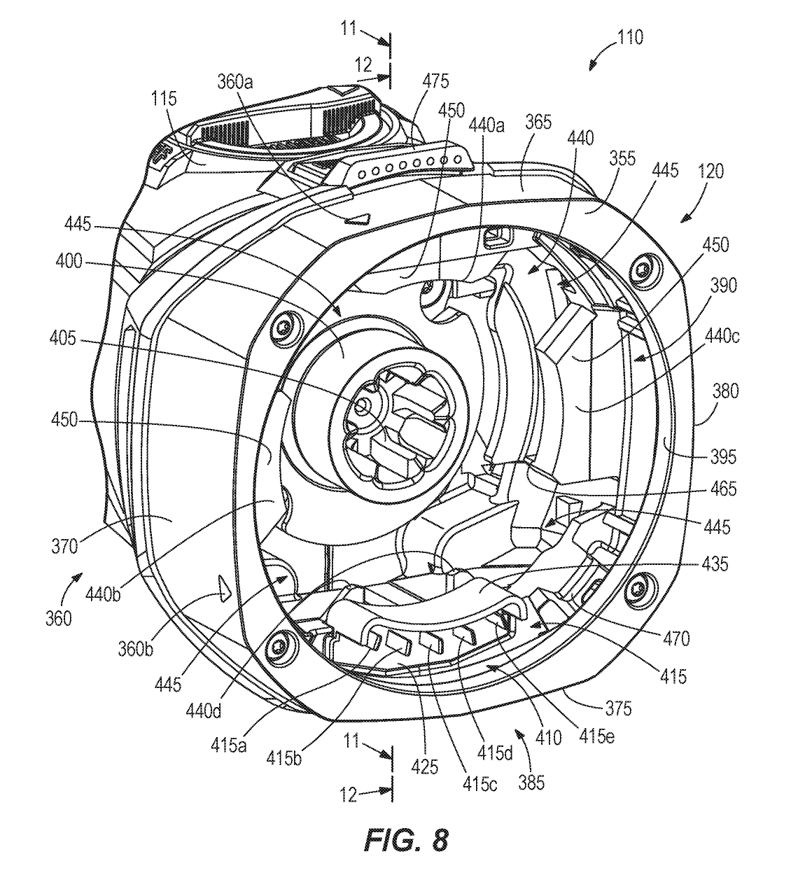

With reference to FIGS. 8-12, one power tool implement 110 is illustrated but includes similar features and components to the first, second, and third power tool implements 110a, 110b, 110c. As such, one power tool implement 110 will be described below in detail and represents one embodiment of the power tool implements 110a, 110b, 110c.

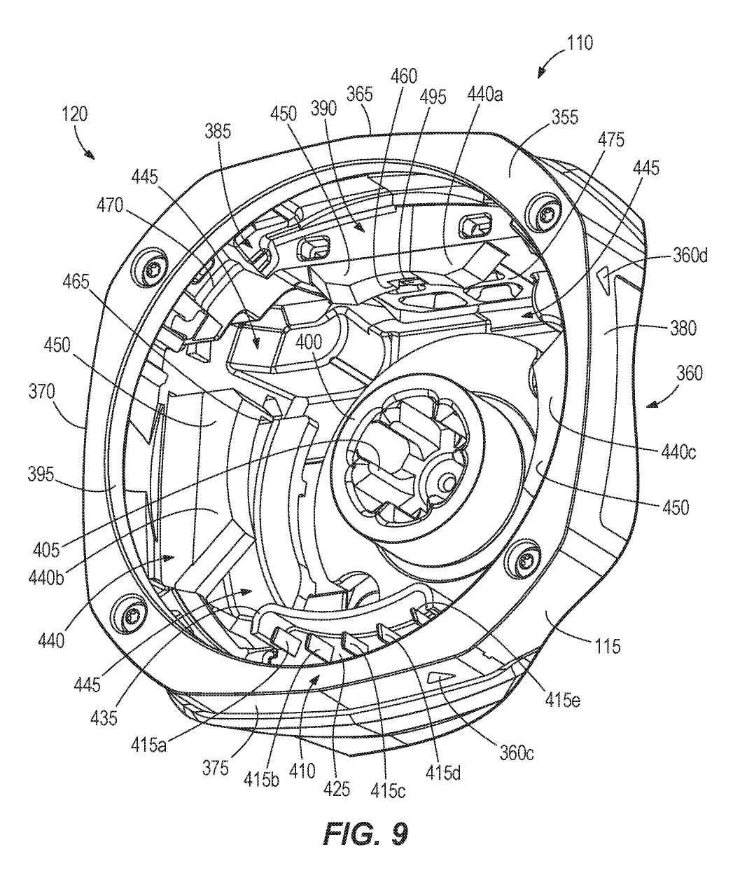

The illustrated power tool implement 110 includes an attachment end housing 355 formed at the attachment end 120. The attachment end housing 355 includes orientation markings 360 positioned on an outer surface of the attachment end housing 355 and are configured to align with the first alignment marking 215 or the lock alignment marking 220 of the power tool base 105, as described in more detail below. A first orientation marking 360a (e.g., a 0-degree orientation marking; FIG. 8) is positioned on a top surface 365 of the attachment end housing 355, a second orientation marking 360b (e.g., a 90-degree orientation marking; FIG. 8) is positioned on a first side surface 370 of the attachment end housing 355, a third orientation marking 360c (e.g., a 180-degree orientation marking; FIG. 9) is positioned on a bottom surface 375 of the attachment end housing 355, and a fourth orientation marking 360d (e.g., a 270-degree orientation marking; FIG. 9) is positioned on a second side surface 380 of the attachment end housing 355.

With reference to FIGS. 8 and 9, the power tool implement 110 includes a power tool base interface assembly 385 positioned within a cavity 390 of the power tool implement 110, which is partially defined by an opening 395 of the attachment end housing 355. The power tool base interface assembly 385 includes an input spindle 400, which includes teeth 405, rotatable about the rotational axis 180. The input spindle 400 is operable to drive the working end 125 of the power tool implement 110. In addition, the teeth 405 of the input spindle 400 are sized and configured to engage the teeth 185 of the output spindle 175 of the power tool base 105 to transfer rotational power from the power tool base 105 to the power tool implement 110.

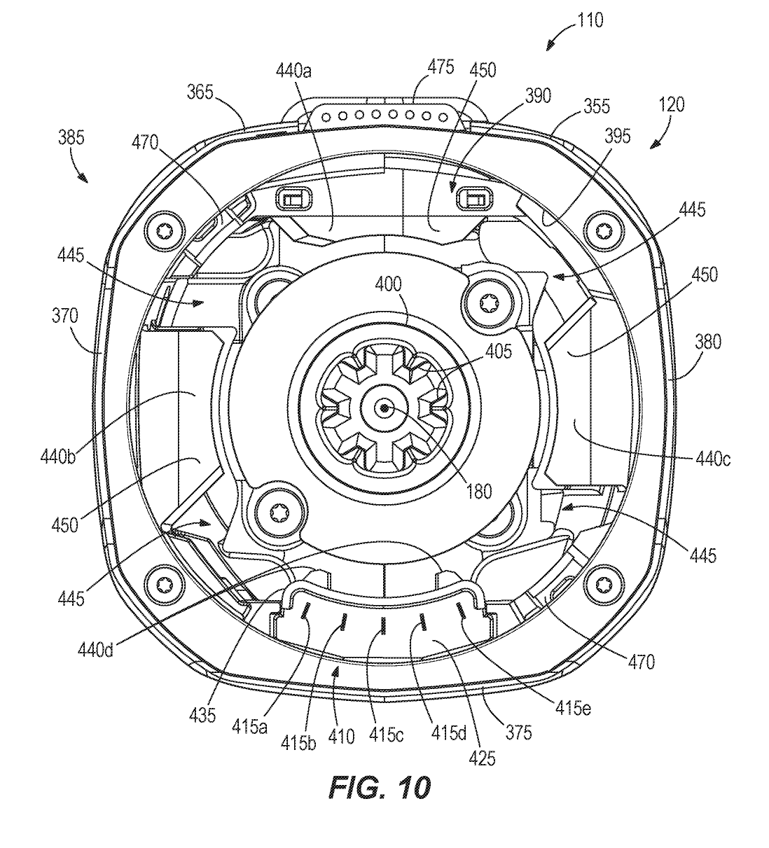

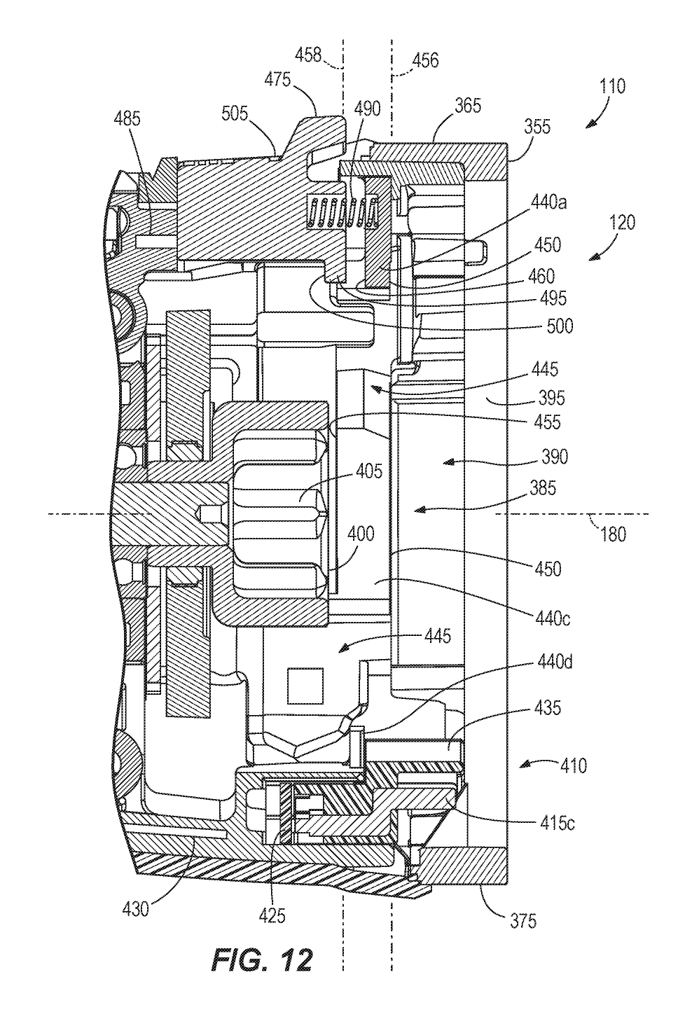

As shown in FIGS. 8-10, the power tool base interface assembly 385 also includes an electrical interface portion or interface protrusions 410 fixed to the attachment end housing 355 adjacent the bottom surface 375. In other embodiments, the interface protrusions 410 can be located adjacent the top surface 365, the first side surface 370, and/or the second side surface 380. The illustrated interface protrusions 410 include electrical terminal protrusions 415 coupled to a printed circuit board 425 (e.g., PCB; FIG. 12). The electrical terminal protrusions 415 include five protrusions, for example, a first terminal protrusion 415a is a power terminal protrusion, a second terminal protrusion 415b is a ground terminal protrusion, a third terminal protrusion 415c is a first communication or data terminal protrusion, a fourth terminal protrusion 415d is a second communication or data terminal protrusion, and a fifth terminal protrusion 415e is a clock or timer terminal protrusion. The illustrated communication terminal protrusions 415c, 415d are operable to convey information parameters from the specific power tool implement 110 to the power tool base 105. For example, the information parameters can include if the working end 125 of the specific power tool implement 110 can be rotated in two directions in which the directional actuation button 205 would be operable, if the specific power tool implement 110 is operable with the lock-off function that is disabled by the control button 195, and if the specific power tool implement 110 is operable with the lock-on function that is enabled by the control button 195. In addition, the information parameters can include current limits, bit package or serial communication, functionality of the power actuation trigger 190, functionality of the light actuation trigger 206, etc. The illustrated clock terminal protrusion 415e provides a timer for the communication terminal protrusions 415c, 415d. The illustrated power terminal protrusion 415a and the ground terminal protrusion 415b are electrically coupled to a light source 420 (FIGS. 1 and 2) of the power tool implement 110 by wires extending through a passageway 430 with the passageway 430 extending from the attachment end housing 355 toward the working end 125 within the housing 115 (a portion of the passageway 430 is illustrated in FIG. 12). The light source 420 is operable to illuminate a desired work area (e.g., the area where the tool, which is coupled to the power tool implement 110, engages a work surface). In other embodiments, the electrical terminal protrusions 415 can include more or less than five terminal protrusions. In further embodiments, the types of electrical terminal protrusions 415 can be arranged in any order. The illustrated interface protrusions 410 also include a guide protrusion 435 that at least partially surrounds the electrical terminal protrusions 415 in a direction extending between the first side surface 370 and the second side surface 380 (FIG. 10). In addition, the electrical terminal protrusions 415 are positioned between the guide protrusion 435 and the bottom surface 375 in a radial direction relative to the rotational axis 180 (FIG. 12). The illustrated guide protrusion 435 also extends further beyond the electrical terminal protrusions 415 in a direction parallel to the rotational axis 180 (FIG. 12).

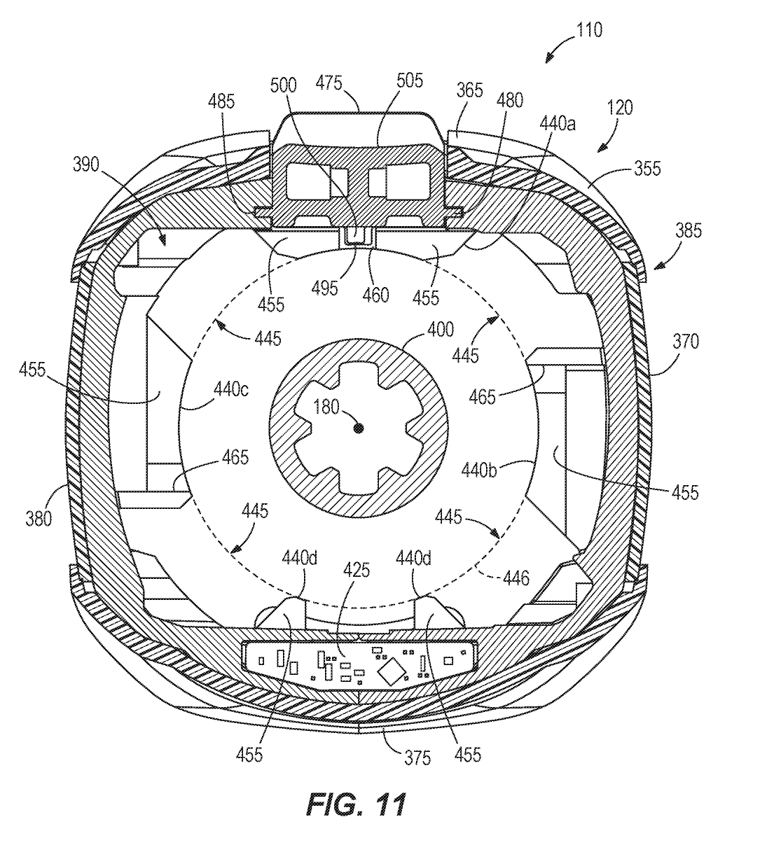

The power tool base interface assembly 385 further includes a mechanical interface portion or tabs 440 extending from the top, side, and bottom surfaces 365, 370, 375, 380 radially inward toward the rotational axis 180. In the illustrated embodiment, the tabs 440 define four discrete tabs that include a top tab 440a, a first side tab 440b, a second side tab 440c, and a bottom tab 440d with a gap 445 positioned between adjacent tabs 440. In other embodiments, a single plate member can form all four tabs 440 and the gaps 445 positioned between adjacent tabs 440. With reference to FIG. 11, the four tabs 440 define an inner tab diameter 446, which is less than the outer protrusion diameter 339 of the hub 230. In other embodiments, the diameter 446 defines an opening of the mechanical interface portion 440. As shown in FIGS. 11 and 12, each tab 440 includes a rear tab surface 450 facing rearward away from the working end 125 of the power tool implement and a front tab surface 455 facing forward toward the working end 125. In the illustrated embodiment, the rear tab surfaces 450 of the tabs 440a, 440b, 440c collectively define a rear tab plane 456 (FIG. 12), and the front tab surfaces 455 of the tabs 440a, 440b, 440c collectively define a front tab plane 458 (FIG. 12). In other embodiments, the rear tab surfaces 450 of all four tabs 440 can collectively define the rear tab plane 456, and the front tab surfaces 455 of all four tabs 440 can collectively define the front tab plane 458. The illustrated front tab surface 455 of the top tab 440a includes a notch 460 (FIG. 9), and the front tab surface 455 of the two side tabs 440b, 440c include a stop 465 (FIGS. 8 and 9) extending toward the working end 125 in the direction along the rotational axis 180. The stop 465 formed on the first side tab 440b is closer to the top tab 440a than the bottom tab 440d, and the stop 465 formed on the second side tab 440c is closer to the bottom tab 440d than the top tab 440a (FIG. 11). In other embodiments, the stop 465 formed on the two side tabs 440c, 440d can be omitted. In the illustrated embodiment, the bottom tab 440d is formed as two discrete tabs. In other embodiments, the bottom tab 440d can be formed as a single tab.

With reference back to FIGS. 8-10, the power tool base interface assembly 385 also includes guides 470 positioned adjacent the opening 395 of the cavity 390 that are sized and configured to interface with the grooves 265 formed on the ring 225. The guides 470 are spaced apart 180 degrees relative to each other with each guide 470 positioned between adjacent tabs 440 in an angular direction (FIG. 10). In other words, each guide 470 aligns with a corresponding gap 445. In one embodiment, the attachment end housing 355 can include one guide 470, or the guides 470 can be omitted. In further embodiments, the guide(s) 470 can be positioned anywhere around the opening 395 of the cavity 390.

FIGS. 11 and 12 best illustrate a lock 475 of the power tool implement 110 slidably coupled to the attachment end housing 355 in a direction parallel to the rotational axis 180. In particular, the illustrated lock 475 includes rails 480 each extending from a side of the lock 475. Each rail 480 is received within a slot 485 formed within the attachment end housing 355 to allow the lock 475 to translate. In other embodiments, the lock 475 can include the slot 485 and the attachment end 120 can include the rails 480. Moreover, the lock 475 is biased toward the working end 125 by a biasing member 490 (e.g., a coil spring; FIG. 12). The lock 475 also includes a finger 495 that extends toward the rotational axis 180 and has a forward surface 500 facing the working end 125. The lock 475 is moveable relative to the attachment end housing 355 by an operator engaging a top surface 505 of the lock 475 so that the forward surface 500 can be positioned within the notch 460 of the top tab 440a and flush with the front tab surface 455 of the top tab 440a. In further embodiments, the lock 475 can be pivotable relative to the attachment end 120. In yet further embodiments, the lock 475 can be coupled to the power tool base 105.

The illustrated power tool implement 110 can be selectively coupled to the power tool base 105 in four different orientations by coupling the power tool implement interface assembly 135 with the power tool base interface assembly 385. In order to provide a first orientation (e.g., a 0-degree orientation) of the power tool implement 110 relative to the power tool base 105, the first alignment marking 215 of the power tool base 105 aligns with the first orientation marking 360a of the power tool implement 110 in a direction parallel to the rotational axis 180. As such, the first orientation marking 360a of the power tool implement 110 is offset (e.g., misaligned at generally a 45 degree angle) from the lock alignment marking 220 of the power tool base 105. While maintaining the alignment of the markings 215, 360a, the power tool implement interface assembly 135 is inserted into the cavity 390 of the attachment end housing 355. In particular, the protrusions 315 formed on the hub 230 align with the gaps 445 formed between the tabs 440 so that the protrusions 315 move past the tabs 440 toward the working end 125. In other words, the protrusion plane 336 moves past the rear tab plane 456 to align with the front tab plane 458 (FIGS. 6 and 12). When the protrusions 315 are inserted past the tabs 440, the interface protrusions 410 of the power tool implement 110 are inserted into one of the groups of the interface members 285 on the ring 225 (e.g., the bottom-right interface member 285 as viewed in FIG. 5). Because the guide protrusion 435 is longer than the electrical terminal protrusions 415, the guide protrusion 435 is received within the guide aperture 295 before the electrical terminal protrusions 415 are received within the corresponding electrical terminal aperture 290 to engage with the corresponding terminal connector 300. As such, the guide protrusion 435 aids in alignment of the electrical terminal protrusions 415 with the corresponding electrical terminal aperture 290 for the electrical terminal protrusions 415 to be easily inserted within the electrical terminal apertures 290 (e.g., the guide protrusion 435 inhibits the electrical terminal protrusions 415 from contacting the front surface 280 of the ring 225). Furthermore, when the protrusions 315 are inserted past the tabs 440 and the interface protrusions 410 are inserted into the interface members 285, the guides 470 of the attachment end housing 355 are also inserted into the corresponding grooves 265 formed on the ring 225. In the first orientation, the guides 470 are inserted into the top and bottom grooves 265 as viewed in FIG. 5. The guides 470 are configured to provide more connection points between the attachment end housing 355 and the ring 225 to distribute rotational forces between the power tool implement 110 and the power tool base 105 when both are locked together. The power tool implement 110 is fully inserted onto the power tool base 105, while maintaining alignment with the first orientation marking 360a and the first alignment marking 215, when the output spindle 175 engages with the input spindle 400. In one embodiment, the attachment end housing 355 can also abut the front side 140 of the power tool base 105 when the power tool implement 110 is fully inserted onto the power tool base 105.

Thereafter, the power tool implement 110 is rotated in a direction opposite the first direction 255 so that the first orientation marking 360a moves away from the first alignment marking 215 and toward the lock alignment marking 220. Because the guides 470 and the guide protrusion 435 are engaged with the ring 225, the ring 225 co-rotates with the power tool implement 110 about the rotational axis 180 against the biasing force of the biasing member 250. In addition, as the power tool implement 110 rotates relative to the power tool base 105 about the rotational axis 180, the protrusions 315 angularly move from the gaps 445 and toward an adjacent tab 440 (e.g., the top protrusion 315a moves toward the top tab 440a, the first side protrusion 315b moves toward the first side tab 440b, the second side protrusion 315c moves toward the second side tab 440c, and the bottom protrusion 440d moves toward the bottom tab 440d). Consequently, the edge 340 of the top protrusion 315a comes into contact with the finger 495 of the lock 475, and with continued rotation of the power tool implement 110, the finger 495 slides along the edge 340 against the biasing force of the biasing member 490 so that the finger 495 is pushed into the notch 460 of the top tab 440a for the forward surface 500 of the finger 495 to be aligned with the front tab plane 458.

With further rotation of the power tool implement 110 relative to the power tool base 105, the channel 345 aligns with the notch 460 along the rotational axis 180, and the biasing member 490 biases the lock 475 toward the working end 125 for the finger 495 to be biased into the channel 345. Once the finger 495 is biased into the channel 345, the first orientation mark 360a aligns with the lock alignment mark 220 signaling that the power tool implement 110 is locked onto the power tool base 105 in the first orientation. When the power tool implement 110 is locked onto the power tool base 105, the side surfaces 365, 370, 375, 380 of the attachment end housing 355 are substantially flush with the sides of the power tool base 105 (e.g., the top surface 365 of the power tool implement 110 is substantially flush with the top surface 210 of the power tool base 105). In the illustrated embodiment, the stops 465 are configured to engage the first sides 325 of the protrusions 315 to prevent over rotation of the power tool implement 110 relative to the power tool base 105.

The power tool base 105 can then be operable with the selected power tool implement 110. In particular, once the power actuation trigger 190 is depressed into the grip portion 145, the teeth 185 of the output spindle 175 rotatably engage the teeth 405 of the input spindle 400 to drive the working end 125. For example, rotation of the input spindle 400 can linearly reciprocate the working end 125 of the reciprocating saw implement 110a, or rotation of the input spindle 400 can rotate the working end 125 of the drill implements 110b, 110c.

To disconnect the power tool implement 110 from the power tool base 105, the lock 475 is moved toward the power tool base 105 to position the finger 495 within the notch 460 of the top tab 440a. Thereafter, the power tool implement 110 can be rotated in the first direction 255 so that the protrusions 315 again align with the gaps 445 and the first orientation marking 360a aligns with the first alignment marking 215. The power tool implement 110 is then linearly translated away from the power tool base 105 along the rotational axis 180 to separate the power tool implement 110 from the power tool base 105.

A similar procedure of connecting the power tool implement 110 to the power tool base 105 in the first orientation, as described above, occurs when the power tool implement 110 is coupled to the power tool base 105 in a second orientation (e.g., a 90-degree orientation). For example, the power tool base 105 is oriented relative to the power tool implement 110 so that the first alignment marking 215 aligns with the second orientation marking 360b of the power tool implement 110. As such, the second orientation marking 360b of the power tool implement 110 is offset (e.g., misaligned at generally a 45 degree angle) from the lock alignment marking 220 of the power tool base 105. While maintaining the alignment of the markings 215, 360b, the power tool implement interface assembly 135 is inserted into the cavity 390 of the attachment end housing 355 so that the output spindle 175 engages with the input spindle 400. The interface protrusions 410 are also inserted into the top-right group of interface apertures 285 and the guides 470 are inserted into the left and right grooves 265 as viewed in FIG. 5.

Thereafter, the power tool implement 110 is rotated in the direction opposite the first direction 255 so that the second orientation marking 360b moves toward the lock alignment marking 220. Consequently, the edge 340 of the second side protrusion 315c comes into contact with the finger 495, and with continued rotation of the power tool implement 110, the finger 495 slides along the edge 340 against the biasing force of the biasing member 490 so that the finger 495 is pushed into the notch 460 of the top tab 440a. With further rotation of the power tool implement 110 relative to the power tool base 105, the notch 350 of the second side protrusion 315c aligns with the notch 460, and the biasing member 490 biases the lock 475 toward the working end 125 for the finger 495 to be biased into the notch 350 of the second side protrusion 315c. Once the finger 495 is biased into the notch 350 of the second side protrusion 315c, the second orientation mark 360b aligns with the lock alignment mark 220 signaling that the power tool implement 110 is locked onto the power tool base 105 in the second orientation.

To disconnect the power tool implement 110 from the power tool base 105 in the second orientation, the lock 475 is moved toward the power tool base 105 to position the finger 495 within the notch 460 of the top tab 440a. Thereafter, the power tool implement 110 can be rotated in the first direction 255 so that the second orientation marking 360b again aligns with the first alignment marking 215. The power tool implement 110 is then translated away from the power tool base 105 to separate the power tool implement 110 from the power tool base 105.

In addition, a similar procedure of connecting the power tool implement 110 to the power tool base 105 in the second orientation, as described above, occurs when the power tool implement 110 is coupled to the power tool base 105 in a third orientation (e.g., a 180-degree orientation). For example, the power tool base 105 is oriented relative to the power tool implement 110 so that the first alignment marking 215 aligns with the third orientation marking 360c of the power tool implement 110. As such, the third orientation marking 360c of the power tool implement 110 is offset (e.g., misaligned at generally a 45 degree angle) from the locking alignment marking 220 of the power tool base 105. While maintaining the alignment of the markings 215, 360c, the power tool implement interface assembly 135 is inserted into the cavity 390 of the attachment end housing 355 so that the output spindle 175 engages with the input spindle 400. The interface protrusions 410 are also inserted into the top-left group of interface apertures 285 and the guides 470 are inserted into the top and bottom grooves 265 as viewed in FIG. 5.

Thereafter, the power tool implement 110 is rotated in the direction opposite the first direction 255 so that the third orientation marking 360c moves toward the lock alignment marking 220. Consequently, the edge 340 of the bottom protrusion 315d comes into contact with the finger 495, and with continued rotation of the power tool implement 110, the finger 495 slides along the edge 340 against the biasing force of the biasing member 490 so that the finger 495 is pushed into the notch 460 of the top tab 440a. With further rotation of the power tool implement 110 relative to the power tool base 105, the notch 350 of the bottom protrusion 315d aligns with the notch 460, and the biasing member 490 biases the lock 475 toward the working end 125 for the finger 495 to be biased into the notch 350 of the bottom protrusion 315d. Once the finger 495 is biased into the notch 350 of the bottom protrusion 315d, the third orientation mark 360c aligns with the lock alignment mark 220 signaling that the power tool implement 110 is locked onto the power tool base 105 in the third orientation.

To disconnect the power tool implement 110 from the power tool base 105 in the third orientation, the lock 475 is moved toward the power tool base 105 to position the finger 495 within the notch 460 of the top tab 440a. Thereafter, the power tool implement 110 can be rotated in the first direction 255 so that the third orientation marking 360c again aligns with the first alignment marking 215. The power tool implement 110 is then translated away from the power tool base 105 to separate the power tool implement 110 from the power tool base 105.

Furthermore, a similar procedure of connecting the power tool implement 110 to the power tool base 105 in the third orientation, as described above, occurs when the power tool implement 110 is coupled to the power tool base 105 in a fourth orientation (e.g., a 270-degree orientation). For example, the power tool base 105 is oriented relative to the power tool implement 110 so that the first alignment marking 215 aligns with the fourth orientation marking 360d of the power tool implement 110. As such, the fourth orientation marking 360d of the power tool implement 110 is offset (e.g., misaligned at generally a 45 degree angle) from the locking alignment marking 220 of the power tool base 105. While maintaining the alignment of the markings 215, 360d, the power tool implement interface assembly 135 is inserted into the cavity 390 of the attachment end housing 355 so that the output spindle 175 engages with the input spindle 400. The interface protrusions 410 are also inserted into the bottom-left group of interface apertures 285 and the guides 470 are inserted into the right and left grooves 265 as viewed in FIG. 5.

Thereafter, the power tool implement 110 is rotated in the direction opposite the first direction 255 so that the fourth orientation marking 360d moves toward the lock alignment marking 220. Consequently, the edge 340 of the first side protrusion 315b comes into contact with the finger 495, and with continued rotation of the power tool implement 110, the finger 495 slides along the edge 340 against the biasing force of the biasing member 490 so that the finger 495 is pushed into the notch 460 of the top tab 440a. With further rotation of the power tool implement 110 relative to the power tool base 105, the notch 350 of the first side 315b aligns with the notch 460, and the biasing member 490 biases the lock 475 toward the working end 125 for the finger 495 to be biased into the notch 350 of the first side protrusion 315b. Once the finger 495 is biased into the notch 350 of the first side protrusion 315b, the fourth orientation mark 360d aligns with the lock alignment mark 220 signaling that the power tool implement 110 is locked onto the power tool base 105 in the fourth orientation.

To disconnect the power tool implement 110 from the power tool base 105 in the fourth orientation, the lock 475 is moved toward the power tool base 105 to position the finger 495 within the notch 460 of the top tab 440a. Thereafter, the power tool implement 110 can be rotated in the first direction 255 so that the fourth orientation marking 360d aligns with the first alignment marking 215. The power tool implement 110 is then translated away from the power tool base 105 along the rotational axis 180 to separate the power tool implement 110 from the power tool base 105.

In other embodiments, the power tool implement 110 can be coupled to the power tool base 105 in more or less than four different orientations. As described above, the number of protrusions 315 formed on the hub 230 and the number of interface groups 285 formed on the ring 225 correspond to the number of different orientations of the power tool implement 110. As such, by changing the number of protrusions 315 and the interface groups 285, the number of different orientations of the power tool implement 110 will also change.

In other embodiments, the interface assembly 135 can be coupled to the power tool implement 110 and the interface assembly 385 can be coupled to the power tool base 105. For example, a portion of the power tool implement 110 can be received within a cavity formed by the power tool base 105. In further embodiments, the interface assembly 135 can include the ring 225 and the tabs 440 or the interface assembly 135 can include the hub 230 and the protrusions 410. In yet further embodiments, the interface assembly 385 can include the ring 225 and the tabs 440 or the interface assembly 135 can include the hub 230 and the protrusions 410.

Although the invention has been described with reference to certain preferred embodiments, variations and modifications exist within the scope and spirit of one or more independent aspects of the invention as described.

1. A power tool comprising:
a power tool base including
a base housing, and
a motor supported by the base housing; and
a power tool implement selectively coupled to the power tool base, the power tool implement including
an implement housing, and
a working end coupled to the implement housing;
wherein one of the power tool base and the power tool implement includes a first interface portion having a protrusion, wherein the other one of the power tool base and the power tool implement includes a second interface portion having an opening configured to receive the first interface portion; and
wherein the power tool implement is coupled to the power tool base in response to axially moving the first interface portion into the second interface portion and rotating the implement housing relative to the base housing such that the protrusion of the first interface portion engages the second interface portion.

2. The power tool of claim 1, wherein the second interface portion includes a plurality of tabs and a gap positioned between the plurality of tabs, and wherein the protrusion of the first interface portion extends through the gap before engaging one of the plurality of tabs to couple the power tool implement to the power tool base.

3. The power tool of claim 1, wherein one of the power tool base and the power tool implement includes a locking member, and wherein the locking member is received within a notch of the protrusion to rotationally lock the power tool implement relative to the power tool base.

4. The power tool of claim 1, wherein the power tool implement is selectively coupled to the power tool base in a first orientation and a second orientation, and wherein the first orientation is angularly offset relative to the second orientation.

5. The power tool of claim 1, wherein the power tool base includes an output spindle driven by the motor, and wherein the power tool implement includes an input spindle engageable with the output spindle for the output spindle to drive the working end of the power tool implement.

6. A power tool comprising:
a power tool base including
a base housing,
a motor supported by the base housing, and
a control processor coupled to the motor; and
a power tool implement selectively coupled to the power tool base, the power tool implement including
an implement housing, and
a working end coupled to the implement housing;
wherein one of the power tool base and the power tool implement includes a first interface portion having a first electrical contact moveable relative to the one of the power tool base and the power tool implement in which the first interface portion is coupled to, wherein the other one of the power tool base and the power tool implement includes a second interface portion having a second electrical contact fixed relative to the one of the power tool base and the power tool implement in which the second interface portion is coupled to; and
wherein the control processor is electrically coupled to the power tool implement in response to the first electrical contact engaging the second electrical contact.

7. The power tool of claim 6, wherein the first interface portion moves with the one of the power tool implement and the power tool base that the second interface portion is coupled to in response to the first electrical contact engaging the second electrical contact and the power tool implement rotating relative to the power tool base.

8. The power tool of claim 6, wherein the first interface portion includes a guide aperture associated with the first electrical contact, and wherein the guide aperture is configured to receive a non-electrical guide protrusion associated with the second electrical contact to guide the first electrical contact into contact with the second electrical contact.

9. The power tool of claim 6, wherein the first interface portion includes a first group of electrical contacts having the first electrical contact, and wherein the first interface portion includes a second group of electrical contacts angularly spaced relative to the first group of electrical contacts.

10. The power tool of claim 9, wherein the power tool implement is couplable to the power tool base in a first orientation with the second electrical contact engaging the first electrical contact of the first group of electrical contacts, and wherein the power tool implement is couplable to the power tool base in a second orientation angularly offset relative to the first orientation with the second electrical contact engaging one electrical contact of the second group of electrical contacts.

11. A power tool comprising:
a power tool base configured to be selectively coupled to a power tool implement, the power tool base including
a housing having a front end,
a motor supported by the housing,
a control processor coupled to the motor,
an output spindle driven by the motor about a rotational axis,
a mechanical interface portion coupled to the front end of the housing, the mechanical interface portion having a protrusion, the protrusion configured to engage the power tool implement to mechanically couple the power tool base to the power tool implement, and
an electrical interface portion positioned adjacent the front end of the housing, the electrical interface portion movable relative to the mechanical interface portion, the electrical interface portion having a base electrical contact coupled to the control processor, the base electrical contact configured to engage an implement electrical contact of the power tool implement to electrically couple the power tool implement to the power tool base.

12. The power tool of claim 11, wherein the protrusion of the mechanical interface portion includes a rear facing surface facing the electrical interface portion, and wherein the rear facing surface is configured to engage a tab of the power tool implement to mechanically couple the power tool base to the power tool implement.

13. The power tool of claim 12, wherein the mechanical interface portion is a cylindrical hub fixed to the front end of the housing configured to be received within a housing of the power tool implement.

14. The power tool of claim 11, wherein the electrical interface portion includes a guide aperture associated with the base electrical contact, and wherein the guide aperture is configured to receive a non-electrical guide protrusion of the power tool implement for the guide protrusion to guide the implement electrical contact into contact with the base electrical contact.

15. The power tool of claim 14, wherein the electrical interface portion is a ring rotatable about the rotational axis.

16. A power tool comprising:
a power tool implement configured to be selectively coupled to a power tool base, the power tool implement including
a housing having a cavity,
a working end coupled to the housing,
a mechanical interface portion positioned within the cavity, the mechanical interface portion having a tab, the tab configured to engage the power tool base to mechanically couple the power tool implement to the power tool base, and
an electrical interface portion positioned within the cavity, the electrical interface portion having an implement electrical contact configured to engage a base electrical contact of the power tool base to electrically couple the power tool implement to the power tool base.

17. The power tool of claim 16, wherein the tab is one tab of a plurality of tabs, and wherein a gap is formed between the plurality of tabs, and wherein the gap is configured to receive a protrusion of the power tool base for the protrusion to engage a forward facing surface of one of the plurality of tabs.

18. The power tool of claim 17, wherein the forward facing surface includes a stop projecting from the forward facing surface, and wherein the stop is configured to engage the protrusion of the power tool base to prevent over rotation of the power tool implement relative to the power tool base.

19. The power tool of claim 16, wherein the electrical interface portion includes a non-electrical guide protrusion associated with the implement electrical contact, and wherein the electrical guide protrusion is configured to be received within an aperture of the power tool base for the guide protrusion to guide the implement electrical contact into contact with the base electrical contact.

20. The power tool of claim 16, wherein the power tool implement includes a guide positioned within the cavity, and wherein the guide is configured to engage an electrical interface portion of the power tool base to inhibit the electrical interface portion of the power tool base from moving relative to the housing when the power tool implement is being coupled to the power tool base.
